(19) United States
(12) Patent Application Publication
(10) Pub. No.: US 2007/0263220 A1
(43) Pub. Date: Nov. 15, 2007

(54) Optical Measurement System with Simultaneous Multiple Wavelengths, Multiple Angles of Incidence and Angles of Azimuth

(75) Inventors: Tongxin Lu, San Jose, CA (US); Xiaohan Wang, Alameda, CA (US)

Correspondence Address: EMIL CHANG;LAW OFFICES OF EMIL CHANG, 874 JASMINE DRIVE, SUNNYDALE, CA, 94086, US

(73) Assignee: Raintree Scientific Instruments (Shanghai) Corporation, Santa Clara, CA (US)

(21) Appl. No.: 11/747,173

(22) Filed: May 10, 2007

Related U.S. Application Data
(63) Continuation-in-part of application No. 11/735,979, filed on Apr. 16, 2007.
(60) Provisional application No. 60/799,043, filed on May 10, 2006.

(51) Int. Cl. G01J 4/00; G01N 21/55

(52) U.S. Cl. 356/369; 356/445

(57) ABSTRACT

The present invention discloses an optical measurement and/or inspection device that, in one application, may be used for inspection of semiconductor devices. It comprises a light source for providing light rays; a half-parabolic-shaped reflector having an inner reflecting surface, where the reflector having a focal point and an axis of summary, and a device-under-test is disposed thereabout the focal point. The light rays coming into the reflector that is in-parallel with the axis of summary would be directed to the focal point and reflect off said device-under-test and generate information indicative of said device-under-test, and then the reflected light rays exit said reflector. A detector array receives the exited light rays and the light rays can be analyzed to determine the characteristics of the device-under-test.

### PRIORITY CLAIM

This application claims priority from a provisional patent application entitled “An Optical Measurement System with Simultaneous Multiple Wavelengths, Multiple Angles of Incidence and Angles of Azimuth” filed on May 10, 2006, having an application No. 60/799,043. This application is incorporated herein by reference in its entirety. This application is a continuation-in-part of a U.S. non-provisional application entitled “Optical Focusing Devices” having an application Ser. No. 11/735,979 filed on Apr. 16, 2007.

### FIELD OF INVENTION

The present invention relates to the inspection and measurement systems, and in particular, to optical inspection and measurement of devices under test such as semiconductor devices and/or wafers.

### BACKGROUND

Information created by directing a beam of light to reflect off a device-under-test (“DUT”) has a variety of uses. The thickness of the various coatings (either single layer or multiple layers) on the wafer can be determined from a reflectance or relative reflectance spectrum. Also, the reflectance at a single wavelength can be extracted. This is useful where the reflectance of photoresist coated wafers at the wavelength of lithographic exposure tools must be found to determine proper exposure levels for the wafers, or to optimize the thickness of the resist to minimize reflectance of the entire coating stack. The refractive index of the coating can also be determined by analysis of an accurately measured reflectance spectrum.

It is especially useful, for a variety of industrial applications, to measure the thickness of a very thin film (less than about 300 angstroms in thickness) on a sample, by reflectivity phase measurements of the sample. For example, the sample can be a semiconductor wafer with coating, and the very thin film can be coated on a silicon substrate of the wafer.

Because of the process tolerance requirements typically required in the semiconductor manufacturing, an accurate means for obtaining reflectance measurements of a wafer is needed. In conventional reflectance measurement systems, monochromatic or broadband radiation is reflected from the wafer, and the reflected radiation is collected and measured. For example, referring to FIG. 1, in a traditional measurement and/or inspection system, a lens 100 is used where incoming rays 102 refract through the lens 100 and is focused 104 on the DUT 106 and create reflectance information that can be analyzed.

High numerical aperture (“NA”) lens (NA˜0.95) has been used to achieve simultaneous wide range of angle of incidence and angle of azimuth. However it has many limitations. First, it is very difficult to extend the wavelength to UV (e.g. below 400 nm) due to material absorption at UV wavelength. Second, it is very difficult to work with wide broadband radiation, such as from 250 nm to 1000 nm simultaneously due to chromatic aberration. Thirdly, as light passes through the lens, there is the issue of the absorption of light where the intensity of the light is diminished as it passes through the lens.

To achieve consistent performance with broadband radiation, a reflective optics is required. Due to its limited number of variables, the design choices are also limited. For example, the reflective objective of Schwarzchild design has limited NA and central beam obstruction. It can not achieve wide range of angle of incidence. Aspherical reflective surfaces are also widely used. However it is mostly used in very traditional fashion, i.e. the axis of symmetry is perpendicular to the surface. The range of angle of incidence is also limited.

By analyzing the properties of reflected or transmitted beam, the properties of the surface can be deduced. The properties of the reflected or transmitted beams include intensity, polarization, phase, angles of reflection, wavelength, etc. The properties of surface include reflectivity, thin film thickness, index of refraction of the surface or the thin film, microstructure of the surface, particles on the surface, defects on the surface and surface roughness, etc.

The more information that is detected about the reflected or transmitted beam, the more information can be deduced about the surface property. To that goal, it is desirable to have an invention which allow the detection of (1) a full range of angle of incidence (0 to near 90 degrees); (2) a wide range of azimuth angle; (3) a very wide arrange of wavelengths; and (4) any state of polarization.

Therefore, it is desirable in optical measurement and inspection systems that the optical beam can incident on the object from different incidence angles or different azimuth angles. It is further desirable that the beam is of multiple wavelengths or continues broadband radiation.

### SUMMARY OF THE INVENTION

An object of the present invention is to provide methods and devices that can achieve a full range of angle of incidence (0 degree to near 90 degree) with reflective surfaces.

Another object of the present invention is to provide methods and devices that can achieve a wide range of azimuth angle.

Another object of the present invention is to provide methods and devices that can achieve a very wide arrange of wavelengths.

Another object of the present invention is to provide methods and devices that can measure any state of polarization.

Briefly, the present invention discloses an optical measurement device, comprising of: a light source for providing light rays; a half-parabolic-shaped reflector having an inner reflecting surface, wherein said reflector having a focal point and an axis of summary, and a device-under-test is disposed thereabout the focal point; wherein the light rays coming into the reflector that is in-parallel with the axis of summary would be directed to the focal point and reflected off said device-under-test and generate information indicative of said device-under-test; wherein said reflected light rays exit said reflector; and a detector array for receiving the exited light rays.

An advantage of the present invention is that it provides methods and devices that can achieve a full range of angle of incidence (0 degree to near 90 degree) with reflective surfaces.

Another advantage of the present invention is that it provides methods and devices that can achieve a wide range of azimuth angle.

Another advantage of the present invention is that it provides methods and devices that can achieve a very wide arrange of wavelengths.

Another advantage of the present invention is that it provides methods and devices that can achieve any state of polarization.

### DRAWINGS

The following are further descriptions of the invention with reference to figures and examples of their applications.

FIG. 1 is an illustration of a prior art technology for focusing a light beam using lenses for inspection and/or measurement systems;

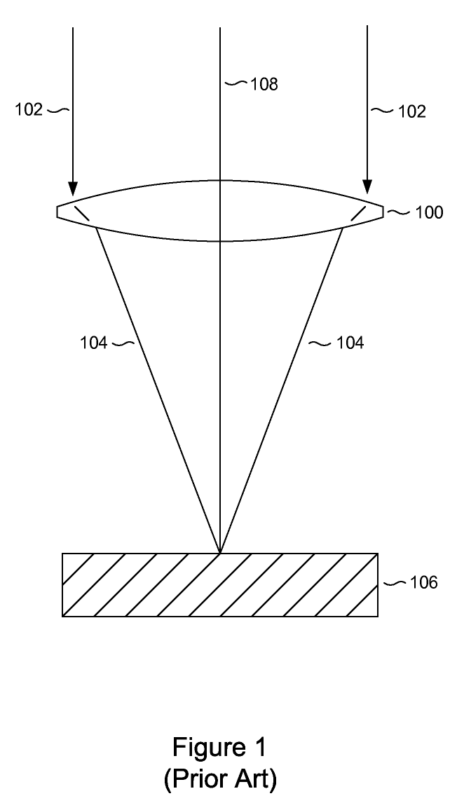

FIG. 2 is a two-dimensional conceptual illustration of the technology of the present invention;

FIG. 3 is a three-dimensional top-side view of a preferred embodiment of the present invention;

FIG. 4 is a view into the parabolic reflector of the present invention;

FIG. 5 is side view of the parabolic reflector of the present invention;

FIG. 6 is a top view of a parabolic reflector of the present invention;

FIG. 7 is another embodiment of the present invention where the light source is placed at the focal point of the parabolic reflector;

FIG. 8 is another embodiment of the present invention where the light detector is placed at the focal point of the parabolic reflector;

FIG. 9 illustrates a parabolic reflector placed in conjunction with a detector array connected to one or more spectrometers;

FIG. 10 illustrates a side view of a parabolic reflector with a wave length filter wheel, a beam splitter, and a detector array;

FIG. 11A illustrates a top view of a parabolic reflector with a wavelength filter wheel, a beam splitter, and a detector array;

FIG. 11B illustrates a band pass filter graph corresponding with the wavelength filters on the filter wheel of FIG. 111A;

FIG. 12 illustrates a side view of a parabolic reflector with a polarizer, wave plate, beam splitter, and an analyzer;

FIG. 13 illustrates a side view of a parabolic reflector with a polarizer, beam splitter, a filter wheel near the light source, a filter wheel near the detector array, an analyzer, and a detector array;

FIG. 14A illustrates a side view of another parabolic reflector with a tunable light source, a polarizer, beam splitter, a filter wheel, and an analyzer;

FIG. 14B illustrates a side view of a parabolic reflector with multiple laser beams as light source, a polarizer, beam splitter, a filter wheel, and an analyzer;

FIG. 14C illustrates a side view of a parabolic reflector with a tunable filter, a polarizer, a beam splitter, a filter wheel, and an analyzer;

FIG. 15 illustrates an embodiment of the present invention in the transmission mode;

FIG. 16 illustrates another embodiment of the present invention having an opening on the reflector at the normal position for allowing a strong light to pass through to inspect the DUT in particular for particles;

FIG. 17 illustrates another embodiment of the present invention having an opening on the reflector at the normal position for allowing a strong light to pass through to inspect the DUT in particular for roughness measurements; and

FIG. 18 illustrates another embodiment of the present invention having an opening on the reflector at a side position for allowing a strong light to pass through to inspect the DUT for the detection of small particles.

### DETAILED DESCRIPTIONS OF THE PREFERRED EMBODIMENTS

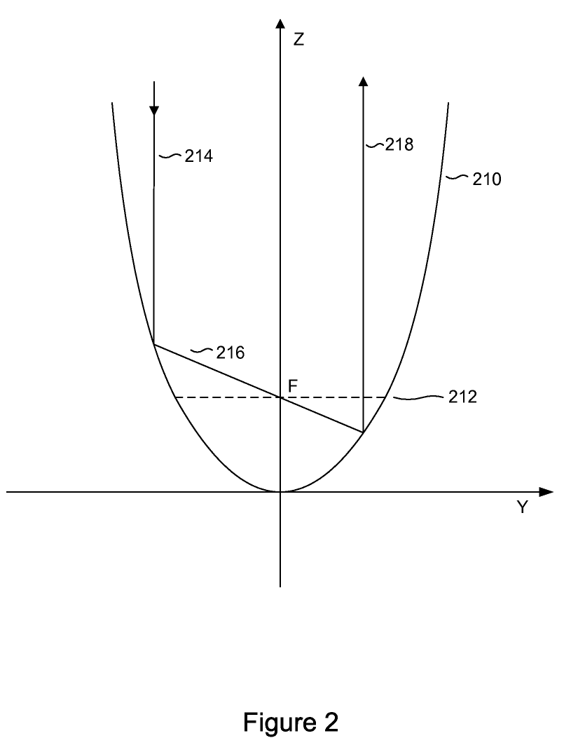

Referring to FIG. 2, a key underlying concept of the embodiments of the present invention is explained. Given a parabola 210 disposed on a y-axis and a z-axis, conceptually, the shape of the parabola can be described be a simple mathematical function, z=ay², where incoming rays parallel to the z-axis would intersect the z-axis at its focal point “F”, where the focal point is at (0, ¼a), and “a” is a constant. The incoming ray intersects the parabolic surface and it is redirected towards the focal point at the incident plane 212 (the plane that is perpendicular to the axis of symmetry and passes through the focal point, “F”).

Here, as shown, the incidental incoming light ray 214 is parallel to the axis of symmetry. The ray hits the parabolic surface and the parabolic reflector, by virtue of its properties, directs the beam towards its focal point and intersects the z-axis at intersection point “F”. After the intersection, the ray hits the parabolic surface again, and the parabolic surface re-directs the ray 218 back toward its incident direction parallel to the axis of symmetry. Due to the unique characteristic of the paraboloid, reflected ray will be always be parallel to the axis of symmetry if the incoming ray is parallel to the axis of symmetry.

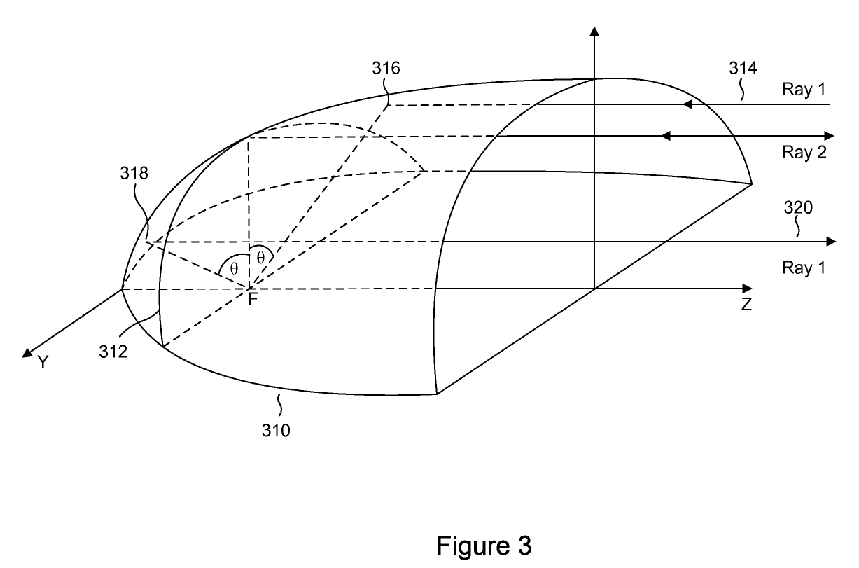

In a presently preferred embodiment of the present invention, referring to FIG. 3, a parabolic reflector 310, which can be in the shape of a half-paraboloid is illustrated. Here, the properties described above for two-dimensional parabolic shapes would hold as well. For example, an incoming ray 314, ray 1, that is coming in parallel to the axis of summary, would reflect off the parabolic surface at 316. The reflected ray would, due to the characteristics of the paraboloid, be directed to the focal point of the paraboloid, point “F”, which is also the point of intersection between the intersection plane 312 and the z-axis, the axis of summary. The ray would reflect off point “F”, create information with respect to the DUT (not shown) and again reflect off a point off the parabolic surface 318 and be re-directed out 320 of the parabolic reflector, which would be read by a detector (not shown). Again, due to the unique characteristic of the paraboloid, reflected ray will be always parallel to the axis of symmetry if the incoming ray is parallel to the axis of symmetry.

The shape of the embodiments of the present invention can be a paraboloid, which can be manufactured by rotating a parabolic curve around its axis of symmetry. The reflector can be made by cutting the paraboloid in two halves along its axis of rotation. In actual use, the preferred embodiment of the present invention can be slightly less than one-half of the paraboloid such that the axis of symmetry of the paraboloid can be located slightly above the surface of the DUT to be measured or inspected. The inner surface of the parabolic reflector would be reflective.

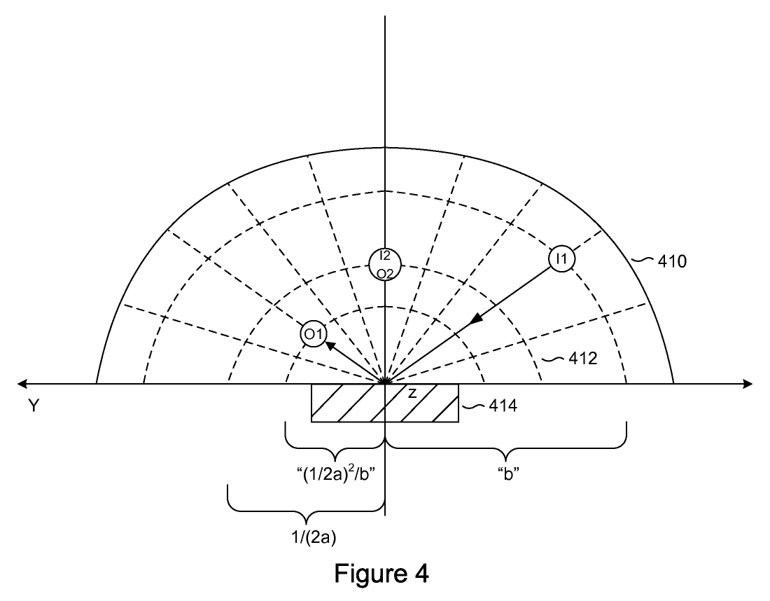

Depending on where the ray intersects the parabolic surface, the ray will intersect the flat surface at different incident and azimuth angles. The relationship between the intersection point on the parabolic surface and the ray angle can be easily calculated. Referring to FIG. 4, in looking into the opening of the parabolic reflector, if we look toward the reflected beam, the parabolic reflector looks like a half hemisphere. Let's image there is a polar coordinates at the end surface of the reflector, the cross-section of incoming beam is a quarter of circle, and the cross-section of the reflected beam is also quarter of circle.

The rays incoming at radius of 1/(2a) will also exit the at the same radius (see incoming ray 1 “I1 ” and outgoing ray 1 “O1”). It is also easy to show that any incoming ray intersects that parabolic surface at a distance from the axis of symmetry of “b”, then the exit ray will intersect the parabolic surface at a distance of (½a)²/b. The angle measured at plane of incidence will be same. So, in polar coordinate (ρ, θ), if the incoming ray has coordinates (ρ, θ), the exit ray will have coordinates of (r²/ρ, π−2θ), where r—1/(2a). A ray, such as ray 2 (“I2” and “O2”) coming in parallel with the z-axis would also exit parallel with the z-axis.

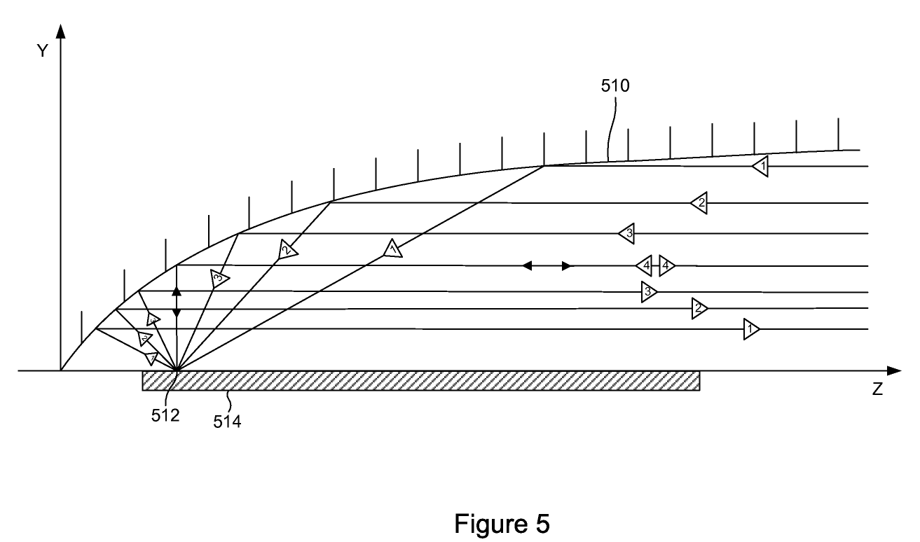

Referring to FIG. 5, a side view of the reflector 510 is illustrated. Here, the focal point (0, ¼a) is at 512, and the DUT can be fairly large when compared to traditional inspection systems. Here, Rays 1, 2, 3 and 4 are coming in parallel with the z-axis, and, as illustrated, after hitting the DUT, the rays are re-directed and reflect off the reflector and re-directed out of the reflector.

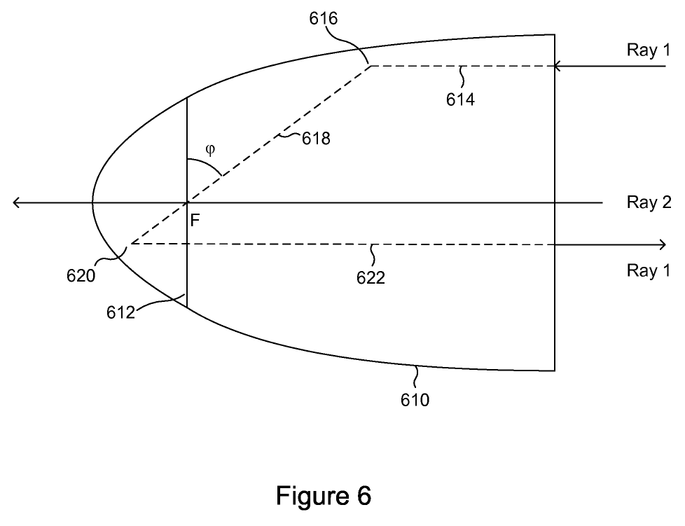

Referring to FIG. 6, a top view of the reflector 610 is illustrated with a plane of incidence 612 and azimuth angle φ. Here, ray 1 comes in 614 parallel to the z-axis and reflects off a point 616 off the reflector and is re-directed 618 to the focal point of the reflector. It then reflects off the DUT (not shown) and again it reflects off the reflector at 620 and exits the reflector parallel to the z-axis 622. Ray 2 enters along and parallel to the z-axis and exits along the same path.

The exiting rays, since it has been reflected off the device-under-test, their characteristics would provide information indicative of the device-under-test. The reflected light rays would be collected by a detecting device and analysis of the reflected light rays would then be conducted. The detecting device can be any type depending the nature of the inspection work or measurement work.

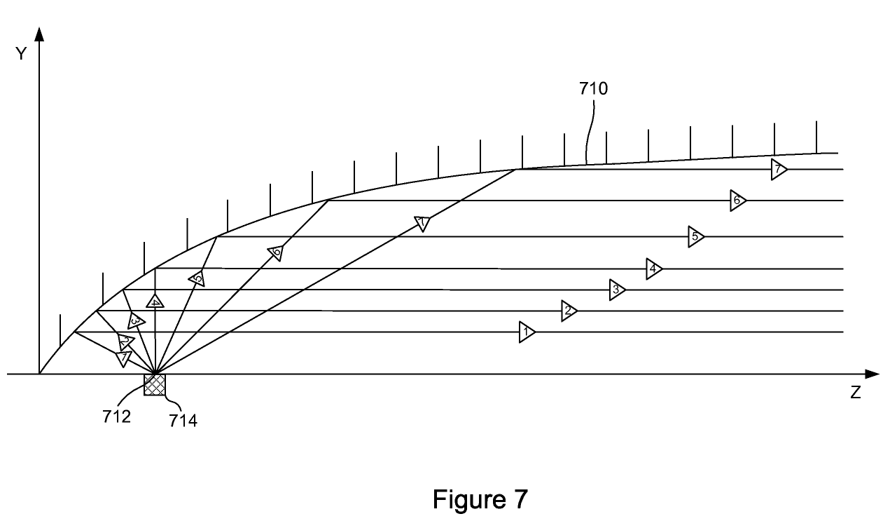

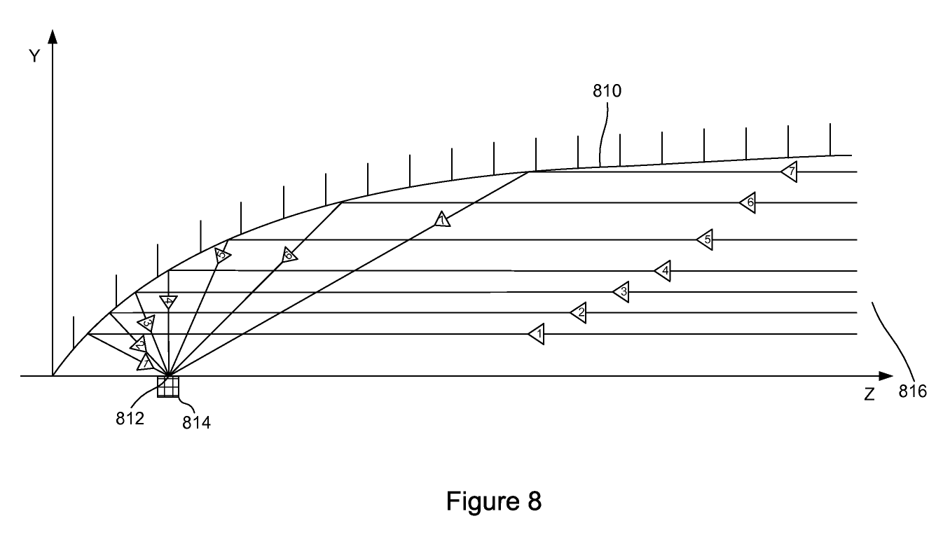

Referring to FIG. 7, in yet another embodiment of the present invention, a light source 714 can be place at the focal point 712, resulting in light emitting from the focal point and be re-directed to generate collimating beams in exiting the reflector. Referring to FIG. 8, in yet another embodiment of the present invention, a light detector 814 can be placed at the focal point 812 to collect light beams coming into the reflector. In yet another embodiment, a light source can be placed at the focal point (see FIG. 7) and a detector can be placed at the focal point (see FIG. 8) as well to collect any light reflected from any DUT, where the DUT can be placed at the opening of the reflector (not shown 816). Alternately, the light detector can be placed at the back of the reflector to collect the collimating beams.

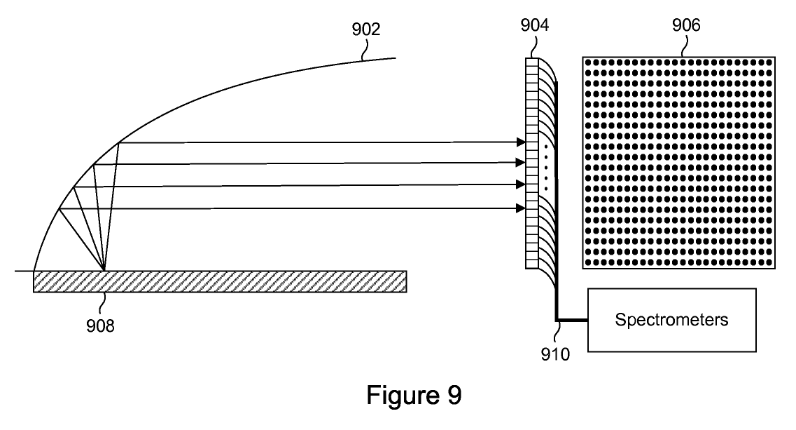

In another embodiment of the present invention, referring to FIG. 9, a parabolic reflector of the present invention 902 is placed with a detector array 904, which can be an n-dimensional array and preferably a two-dimensional detector array 904. The detector array can be an array of optical fibers or switches or other means. The detector array is also a means for providing information with respect to spatial distribution of the reflected light rays. Upon receiving light rays reflected from the parabolic reflector, these light rays can be detected by the detector array and the detected signal is passed to one or more spectrometers via spectrometer input fibers 910. A front view of an example of signal being received by the detector array is illustrated at 906. Information with respect to the position of the received signal on the detector array can be used as well, for example, to calculate the various angles and intensity.

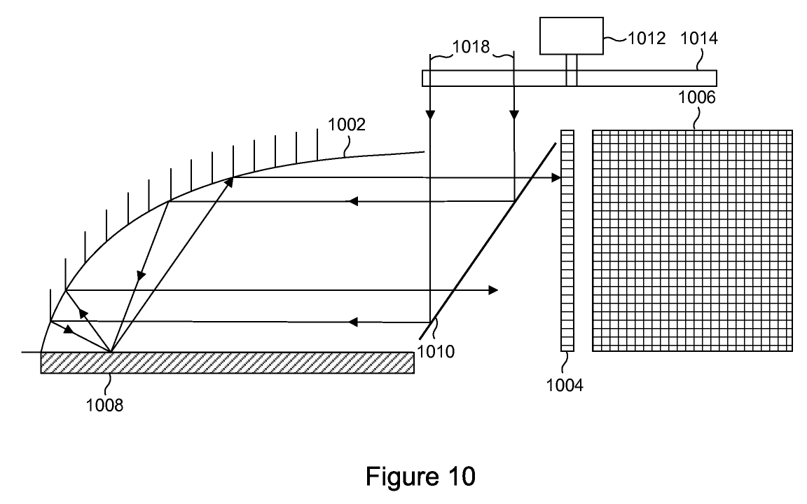

In one embodiment, referring to FIG. 10, a side view of an embodiment coupled with a filter wheel 1014 is illustrated. Here, there is a filter wheel 1014 that can be turned by a motor 1012. Collimated light rays 1018 would pass through a selected wavelength filter of the filter wheel (or a wavelength selector) and be reflected off a mirror, a half-mirror, or beam splitter 1010. The light rays would be reflected toward the parabolic reflector 1002 and be directed to the focal point to reflect off the DUT 1008. The reflected light rays would then again reflect off the parabolic reflector and pass through the half-mirror 101 and be collected by the detector array 1004. A front view of a two-dimensional detector pixel matrix that may collect the light rays is illustrated at 1006.

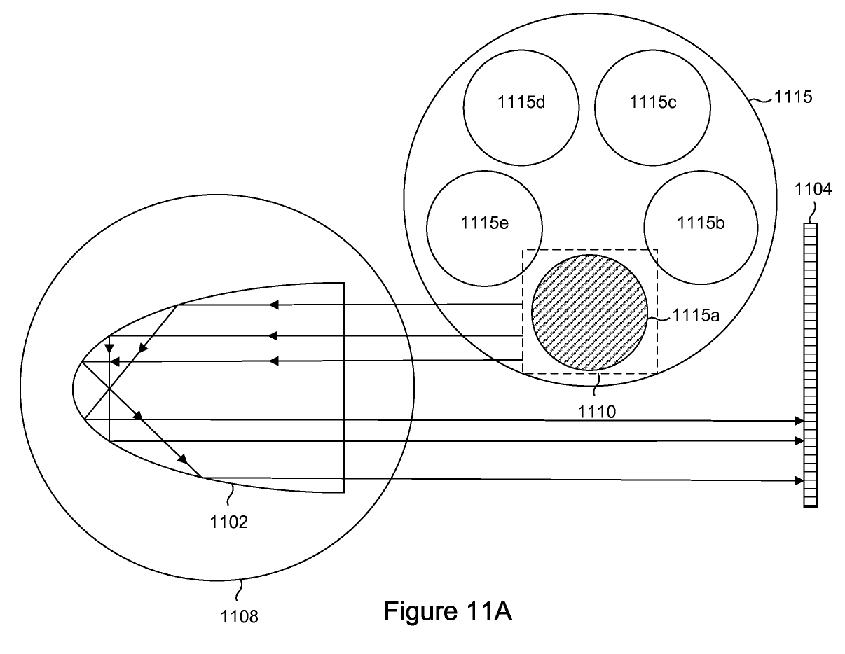

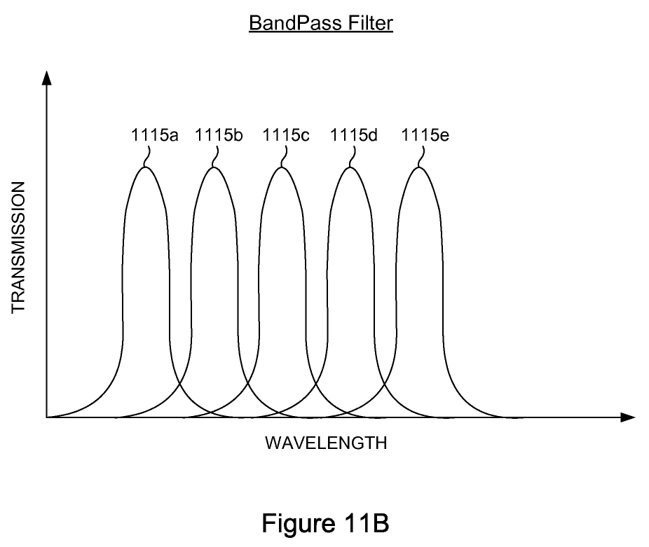

FIG. 11A illustrates a top view of the embodiment illustrated by FIG. 10. Here, the filter wheel 1114 has a number of wavelength filters, 1115A-1115E. The desired wavelength filter can be selected and light beams can be directed to pass through the selected filter and be split off by the half-mirror 1110 and be directed toward the parabolic reflector. After the light rays are reflected off the parabolic reflector and the DUT, it can be collected by the detector array 1104. Note that the half-mirror (beam splitter) can be placed just on one side of the parabolic reflector (as illustrated) or on both sides as well. FIG. 11B illustrates a band pass filter graph illustrating the wavelengths that are passed by the respective wavelength filters illustrated in FIG. 11A (1115A-1115E). With respect to the detector array, each pixel on the detector array can represent one or more types of angles (e.g. incidence angle, diffracted angle, and scattered angle) and one unique azimuth angle at that wavelength. The process can be repeated for each band pass filter on the filter wheel.

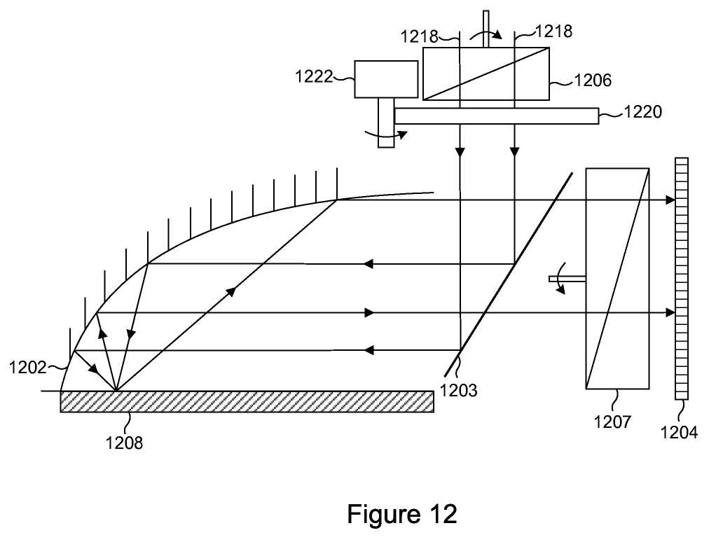

FIG. 12 illustrates yet another embodiment of the present invention. Here, an optional tunable and selectable polarizer 1206 can be added to near the light source such that polarized light rays pass through and reflects off the half-mirror 1203 and the parabolic reflector 1202. An optional tunable and selectable analyzer 1207 can be added near the detector array 1204 in addition to the optional polarizer 1206. The light rays can then be received by the detector array 1204. Additionally, an optional wave plate 1220 (driven by a motor 1222) can be placed near the light source to allow the selection of a particular phase if so desired.

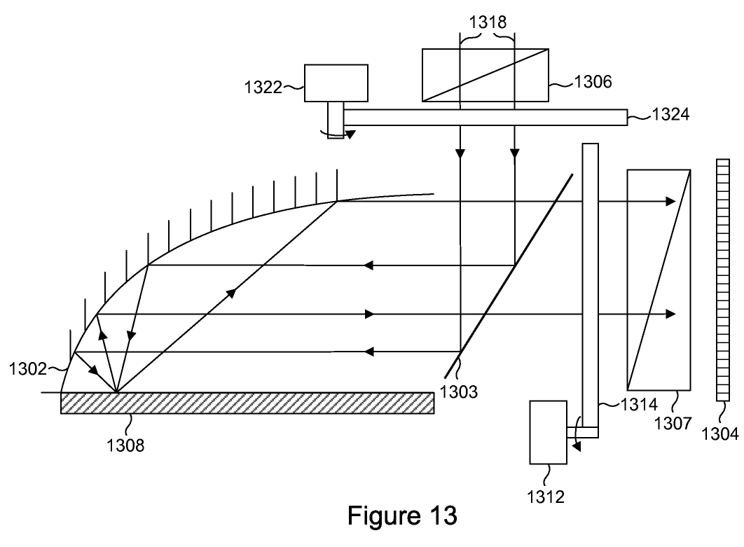

FIG. 13 illustrates yet another embodiment of the present invention where an optional polarizer 1306 and an optional analyzer 1307 are added with a wavelength filter 1308, which can be placed near the light source 1324 or near the detector array 1314. Here, light rays 1318 pass through the polarizer 1306 and the wavelength filter wheel 1324 and split off the half-mirror 1303 and the parabolic reflector 1302 to the DUT 1308. The light rays then reflect off the DUT 1308, and pass through the half-mirror 1303, the filter wheel 1314, and the analyzer 1307 to the detector array 1304. Here, the light rays has been polarized and the wavelength of interest selected.

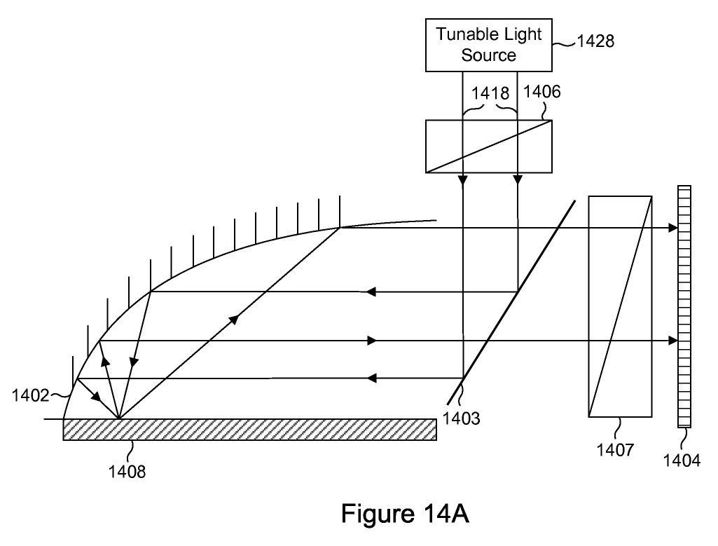

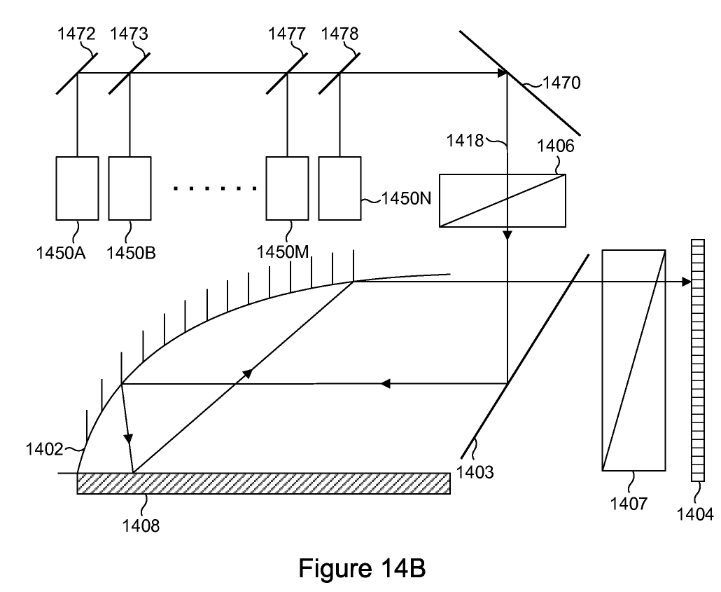

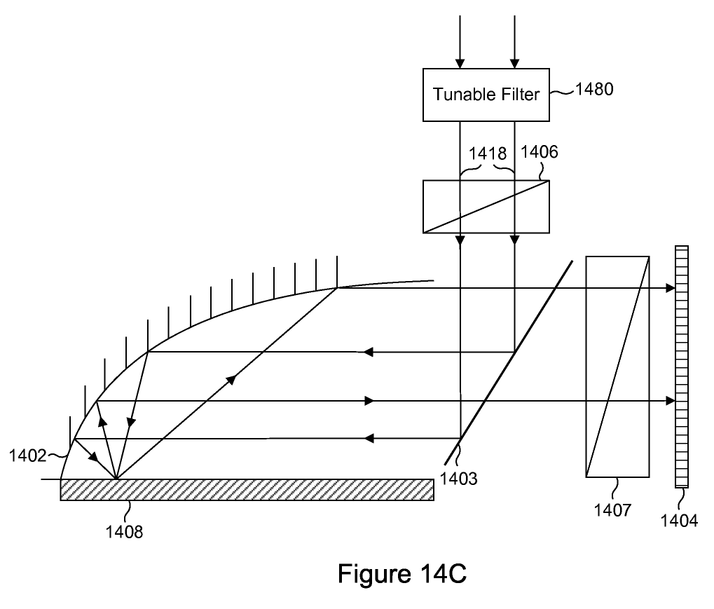

FIGS. 14A-14C illustrate other embodiments utilizing different types of light source. FIG. 14A illustrates an embodiment where the light source 1428 is a wavelength tunable light source. FIG. 14B illustrates an embodiment where the light source is a bank of lasers 1450A-1450M, each with a particular wavelength. Each laser can be selectively turned on or turned off and half mirrors 1472-1478 can be used to reflect the laser beams to the half-mirror 1470. FIG. 14C illustrates an embodiment where the light source passes through a tunable filter 1480.

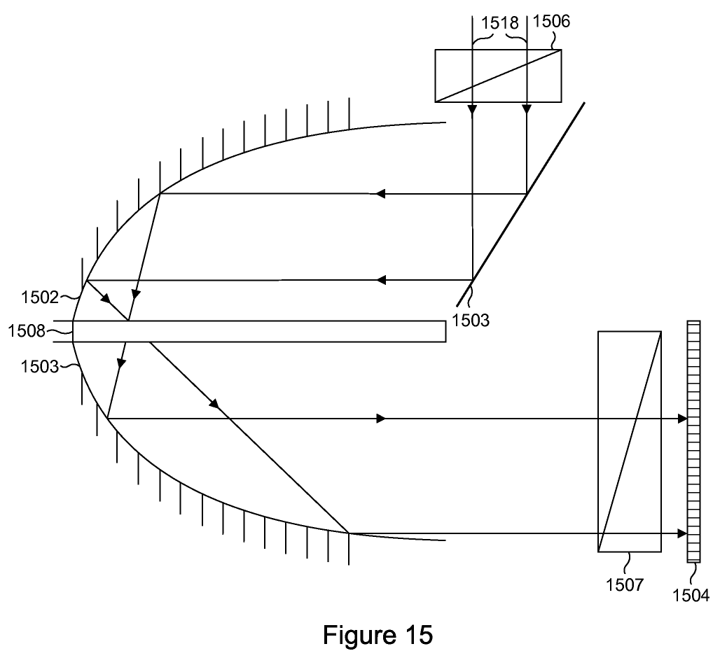

The embodiments of the present invention have been illustrated using the reflecting mode. The present invention can be applied to transmission mode as well where the DUT is transparent where light rays can pass through. FIG. 15 illustrates such embodiment where the DUT 1508 is transparent (of such nature that light can pass through) and light rays 1518 pass through an optional polarizer 1506, reflect off the half-mirror 1503 and the first parabolic reflector 1502, through the DUT 1508. The light rays continue to reflect off the second parabolic reflector 1503, pass through an optional analyzer, and is collected by the detector array 1504. Here, the characteristics of the DUT can be detected, examined, and measured.

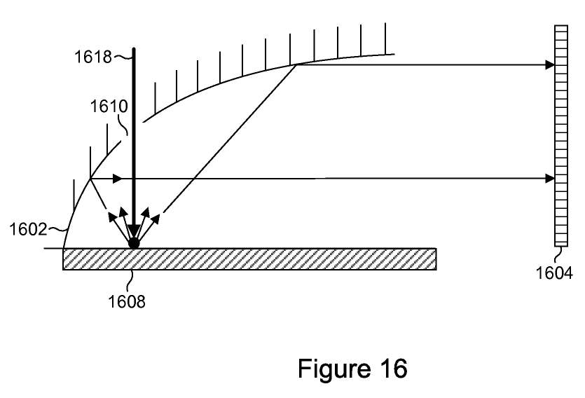

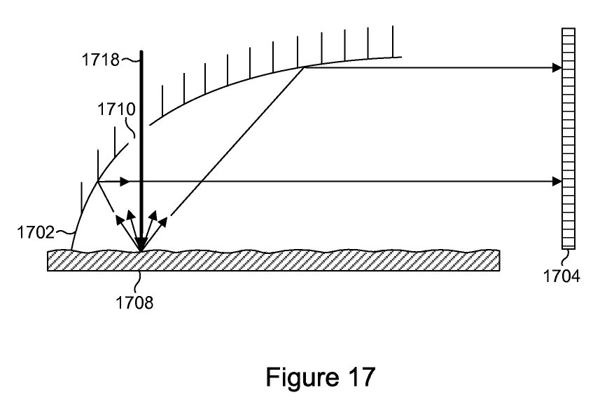

Another embodiment of the present invention is illustrated in FIG. 16. Here, there is an opening 1610 on the parabolic reflector 1602 that is directly above the focal point (the normal position). A strong, pure light, such as a laser beam is directed to the DUT 1608. If a particle is found on the DUT, scattering light rays would be created and be collected by the detector array 1604. In another application, referring to FIG. 17, this embodiment can also detect small particles and surface roughness of the DUT 1708.

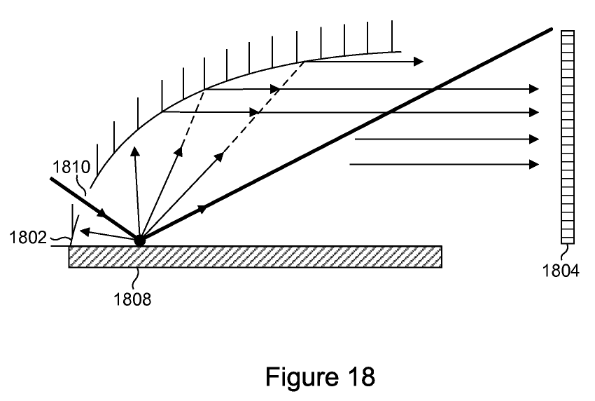

Still another embodiment of the present invention is illustrated in FIG. 18. Here, an opening 1810 is provided on the reflector 1802 where a strong, pure light is provided through an opening 1810 of the reflector 1802 to the DUT 1808. Particles or structures on the DUT 1808 would create a scattering effect and would be collected by the detector array 1804.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We Claim:

1. An optical device, comprising:
a light source for providing incoming light rays;
a half parabolic-shaped reflector having a reflecting surface and a focal point for focusing incoming light rays on a device-under-test, wherein the incoming light rays reflect off from the device-under-test and wherein the reflected light rays provides information indicative of the device-under-test; and
a detecting array for collecting the reflected light rays reflected off from said device-under-test.

2. The device of claim 1 wherein the detecting array is a matrix of detectors wherein the positions of the light rays reflected from the reflector are mapped to the detecting array.

3. The device of claim 1 further comprising a polarizer wherein incoming light rays pass through the polarizer before reflecting off the reflector.

4. The device of claim 1 further comprising an analyzer wherein reflected light rays pass through the analyzer before being collected by the detecting array.

5. The device of claim 3 further comprising an analyzer wherein reflected light rays pass through the analyzer before being collected by the detecting array.

6. The device of claim 1 further comprising a wavelength selector wherein incoming light rays pass through the wavelength selector before reflecting off the reflector.

7. The device of claim 1 further comprising a wavelength selector wherein reflected light rays pass through the wavelength selector before being collected by the detecting array.

8. The device of claim 6 further comprising a wavelength selector wherein reflected light rays pass through the wavelength selector before being collected by the detecting array.

9. The device of claim 1 further comprising a waveplate wherein incoming light rays pass through the waveplate before reflecting off the reflector.

10. The device of claim 1 further comprising a waveplate wherein reflected light rays pass through the waveplate before being collected by the detecting array.

11. The device of claim 9 further comprising a waveplate wherein reflected light rays pass through the waveplate before being collected by the detecting array.

12. The device of claim 1 wherein the light source is a tunable light source.

13. The device of claim 1 wherein the light source is a plurality of selectable laser beams.

14. The device of claim 1 wherein the light source is a tunable laser.

15. The device of claim 1 wherein the light source passes through a tunable filter.

16. An optical device, comprising:
a light source for providing incoming light rays;
a polarizer wherein the incoming light rays pass through said polarizer;
a half parabolic-shaped reflector having a reflecting surface and a focus point for focusing incoming light rays on a device-under-test, wherein the incoming light rays reflect off from the device-under-test and wherein the reflected light rays provides information indicative of the device-under-test;
an analyzer wherein the reflected light rays pass through said analyzer; and
a detecting array for collecting the analyzed reflected light rays reflected off from said device-under-test, wherein the detecting array being a matrix of detectors and the positions of the light rays reflected from the reflector are mapped to the detecting array.

17. The device of claim 16 further comprising a wavelength selector wherein incoming light rays pass through the wavelength selector before reflecting off the reflector.

18. The device of claim 16 further comprising a wavelength selector wherein reflected light rays pass through the wavelength selector before being collected by the detecting array.

19. The device of claim 16 further comprising a waveplate wherein incoming light rays pass through the waveplate before reflecting off the reflector.

20. The device of claim 16 further comprising a waveplate wherein reflected light rays pass through the waveplate before being collected by the detecting array.

21. A method for measuring a DUT, comprising the steps of:
providing incoming light rays to a parabolic surface;
reflecting the light rays off the parabolic surface to the focal point of the parabolic surface to a DUT;
collecting light rays reflected, transmitted, scattered, and diffracted from the DUT;

22. The method of claim 21 wherein the light rays are parallel to the axis of symmetry of the parabolic surface.

23. The method of claim 21 wherein the light rays are collimating light rays.

24. The method of claim 21 wherein the collected light rays are parallel to the axis of symmetry of the parabolic surface.

25. The method of claim 21 wherein the collecting step uses a detector array coupled to one or more spectrometers to collect the light rays.
